(19) United States
(12) Patent Application Publication
(10) Pub. No.: US 2015/0122351 A1
(43) Pub. Date: May 7, 2015

(54) CONTROL VALVE FOR INSTALLING ON AN INTERNAL COMBUSTION ENGINE

(71) Applicant: PIERBURG GMBH, NEUSS (DE)

(72) Inventors: Hans-Ulrich Kuehnel, Moenchengladbach (DE); Sabine Siebrandt, Viersen (DE)

(73) Assignee: PIERBURG GMBH, NEUSS (DE)

(21) Appl. No.: 14/404,452

(22) PCT Filed: May 7, 2013
(86) PCT No.: PCT/EP2013/059482

§ 371 Date: Nov. 27, 2014

(30) Foreign Application Priority Data
May 29, 2012 (DE) 10 2012 104 612.3

(51) Int. Cl. F02M 25/07; F16K 31/04; F16K 27/02; F16K 1/04

(52) U.S. Cl. CPC F02M 25/0797; F16K 1/04; F16K 31/047; F16K 27/029; F02M 25/0788; F02M 25/0773
USPC 137/375

(57) ABSTRACT

A control valve for installation on an internal combustion engine includes a housing comprising an inlet and an outlet. A passage is arranged between the inlet and the outlet and is configured to connect the inlet with the outlet. A control body is configured to control the passage. The control body is fixed to an actuating element. An actuator is configured to move the actuating element. The actuator is fixed to the housing. A heat shield is arranged between the actuator and the internal combustion engine. The heat shield is integrally formed with the housing of the control valve.

The invention relates to a control valve for installing on an internal combustion engine, comprising a housing having an inlet and an outlet, a control body that controls a passage between the inlet and the outlet, an actuating element to which the control body is fastened, an actuator via which the actuating element can be moved and which is fastened to the housing, and a heat shield arranged between the actuator and the internal combustion engine.

Such control valves are used, for example, as exhaust gas recirculation valves, exhaust gas flaps or wastegate valves. When an electromotively driven actuator is used, the components thereof, when mounted on the internal combustion engine, are subjected to high stress by thermal radiation from the surrounding motor elements, which may possibly lead to failure of the electronic components or of the windings of the actuator.

In order to avoid this, various cooling systems are known, with which coolant can be introduced into the housings of the valves, whereby a heat transfer in particular from the hot exhaust gas, and thus to the actuator via the housings, is avoided. Further, metal shielding sheets are arranged between the parts carrying exhaust gas and the actuator. However, these do not reduce the thermal problems arising when the control valve is also mounted immediately in the thermally stressed region of the internal combustion engine, so that the thermal radiation from adjacent components cause additional thermal stress on the control valve.

For this reason, DE 11 2007 003 319 T5 proposes a metal shielding sheet that is fastened on a bearing block serving to be installed on an element of the internal combustion engine and to which a control valve is further mounted, besides the shielding sheet, such that the sheet shields the actuator against thermal radiation from the engine and is arranged between actuator of the valve and the bearing block.

However, this heat shield is manufactured separately in several manufacturing steps and has to be mounted thereafter. Subsequently, the heat shield with the valve and the bearing block must then be fastened to the internal combustion engine. Accordingly, the manufacture and the assembly of the valve with the heat shield are very intricate.

Therefore, it is an object to provide a control valve for installing on an internal combustion engine, which can be fastened to the exhaust gas duct in the immediate vicinity of internal combustion engine parts radiating heat, the fastening requiring as few manufacturing and assembly steps as possible.

This object is achieved with a control valve with the features of the main claim.

Owing to the fact that the heat shield is formed integrally with the housing of the control valve, both a separate manufacture of the heat shield and the additional mounting thereof can be omitted, while at the same time assembly errors by erroneous mounting are excluded. The shielding by this directly cast heat shield is superior to a heat shield of sheet metal.

Correspondingly, the housing preferably is a light metal casting, whereby, on the one hand, light weights are ensured and, on the other hand, a strong shielding is guaranteed.

In a preferred embodiment of the present invention a gearing is arranged between the actuator and the heat shield, by which the actuator is coupled with the actuating element. In this manner, also a subsequent indirect radiation from the heat shield to the actuator is avoided. Further, the assembly of the actuator to the housing remains simple, since the same can be inserted from the free side.

For a full shielding of all heat-sensitive electronic components and coils, the projected area of the actuator without the plug connectors, seen in the direction of the heat shield, is smaller than the heat shield.

Preferably, the heat shield extends substantially semi-circularly around the gearing. In this manner, the heat shield also shields against at least a part of the lateral heat radiation.

In a particularly advantageous embodiment the control valve is a plug-in valve, whose housing can be plugged into a control channel and can be fastened to the control channel via a flange. In this manner, the control valve, complete with the actuator and the heat shield, can be fastened to the control channel by means of a few screws so that no further connections have to be made.

In a preferred embodiment the heat shield extends vertically from the flange by which the control valve is mounted on the control channel. This structure can be realized in a simple manner in a die-casting process, since demolding planes are formed that are vertical relative to one another.

In a further embodiment, an opening is formed in the flange through which a valve rod extends into the gearing, the rod acting as an actuating element. Accordingly, a globe valve with very accurate controlling capacity can be used.

In a still further advantageous embodiment, a mounting plate extends from the flange parallel to the heat shield, which plate accommodates the gearing at least partly and which has the actuator mounted on its side facing from the heat shield. Thus, the actuator can also be fastened to the housing by means of a simple flange connection. The gearing penetrates the mounting plate and can be connected with the valve rod on the opposite side. The necessary assembly effort is correspondingly low.

In order to protect the gearing from an intrusion of liquid or dirt, a gearing cover is fastened on the side of the mounting plate directed toward the heat shield. This cover can be fastened to the mounting plate from the side facing the heat shield, in particular by a simple clip fastening.

According to a preferred use, the control valve is an exhaust gas recirculation valve and the actuator comprises an electric motor. It is particularly advantageous to realize them as plug-in valves, and may be arranged in the area of an exhaust gas heat exchanger such that also the heat transfer from the exhaust gas channel to the actuator is reduced. It is further possible to arrange the valve on the heat exchanger such that the heat absorbed by the heat shield can be discharged via the coolant.

Accordingly, a control valve for installing on an internal combustion engine is provided, which can be manufactures in a few manufacturing steps and is easy and economic to mount, not least because of the small number of individual components. Excessive stress on the electronic components is prevented by shielding the actuator. This allows the arrangement of the valve in the immediate vicinity of heat-radiating components of the internal combustion engine, without thereby affecting the service life of the valve or risking a malfunction.

An embodiment of the present control valve to be used as an exhaust gas recirculation valve is illustrated in the Figures and will be described hereunder.

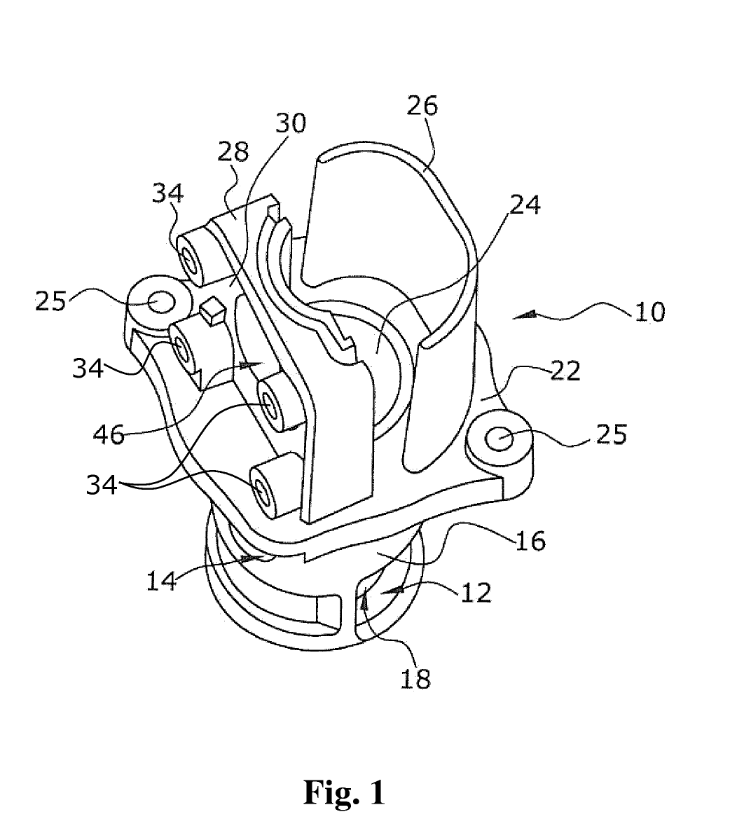

FIG. 1 is a perspective view of a housing of a control valve according to the present invention.

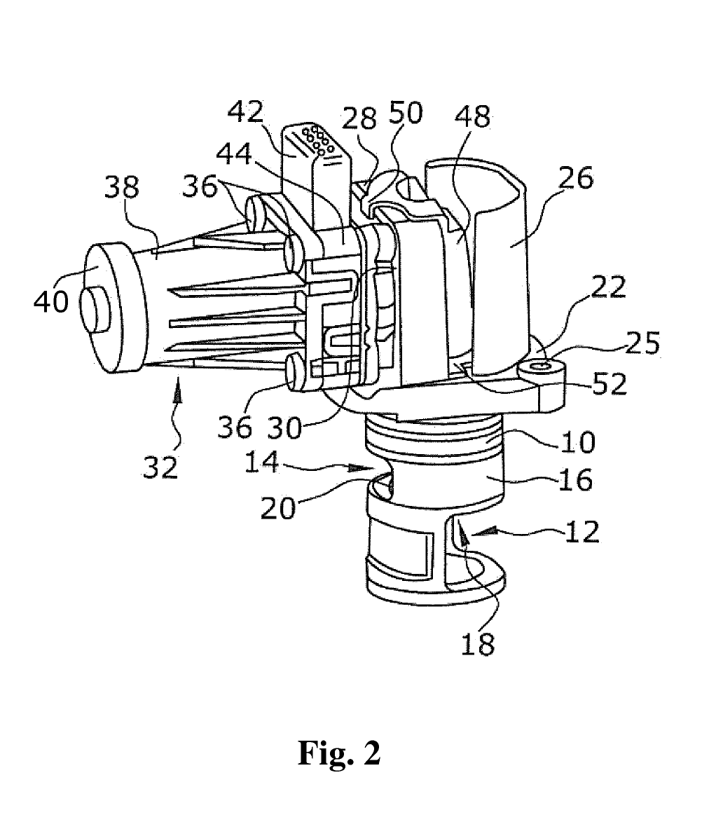

FIG. 2 is a perspective view of a control valve according to the present invention with the housing of FIG. 1.

The control valve of the present invention comprises a housing 10 illustrated in FIG. 1 which is made from light metal in a die-casting process. The control valve is configured as a plug-in valve so that an inlet 12 and an outlet 14 are formed one above the other in a cylindrical base body 16. Between the two windows forming the inlet 12 and the outlet 14, as passage 18 is formed in this base body 16, which is surrounded by a valve seat 20 on which a valve closure member, not visible in the Figures and serving as a control body, can be positioned in the state in which the passage 18 is closed and which can be lifted from the valve seat 20 when in a controlling state.

The control body is fastened to an actuating element which is also not visible and takes the form of a valve rod that extends along the centre axis of the base body 16 and protrudes through a flange 22 that delimits the base body 16 and comprises a central opening 24 for the passage of the valve rod. The flange 22 is formed with two screw holes 25 by which the housing 10 can be fastened to an exhaust gas channel after insertion into the same.

From the surface of the flange 22 a heat shield 26 extends in a direction opposite to the base body 16, as well as a mounting plate 28 which has a flange surface 30 directed in a direction opposite to the heat shield 26. In the present embodiment an electromotive actuator 32 is fastened to this flange surface 30 by four screws 36 inserted into for corresponding screw holes 34, as can be seen in FIG. 2. The electric motor is arranged in an outer housing 38 with an end cap 40, a plug 42 extending outward from a second housing part 44 for power supply to the electric motor, the second housing part being connected with the outer housing 38 by a clip connection.

The mounting plate 28 has a large central opening 46 through which a non-illustrated gearing extends to the valve rod, i.e., into the region between the mounting plate 28 and the heat shield 26, where it is connected in a manner known per se with the valve rod, e.g., by means of an eccentric, so that the rotary movement of the electric motor is converted into a translational movement of the valve rod and thus of the valve closure body. The gearing may in particular be a planetary gearing.

The space into which the gearing protrudes from the opening 46 is closed with a cover 48 that is fastened to the mounting plate 28 by form fit. For this purpose, the cover 48 has a first nose 50 protruding to behind the mounting plate 28, and a second nose 52 clamped between the mounting plate 28 and the heat shield.

The heat shield 26 extends substantially in parallel to the mounting plate 28 and is arc-shaped so that the opening 24 is surrounded by the heat shield 26 over about one half of its circumference. The height of the heat shield 26 substantially corresponds to the height of the mounting plate 28 so that the actuator 32, except for the plug 42, is fully shielded by the heat shield 26 against heat radiation from the side of the heat shield 26 opposite the mounting plate 28.

The control valve, which is preferably used as an exhaust gas recirculation valve, can then be mounted on an internal combustion engine such that the heat shield 26 is directed towards the internal combustion engine. The heat radiation generated at the internal combustion engine is kept from the actuator 32 by the heat shield 26, so that the thermal stress on the actuator is significantly lowered even when it is mounted directly on the internal combustion engine, whereby excessive stress on the electronic components of the actuator 32 is reliably avoided. As already mentioned before, this heat shield 26 is manufactured integrally with the housing 10 of the control valve so that an additional manufacture and mounting of the heat shield are omitted. The electric motor, pre-assembled with the gearing, can be inserted through the opening 30 and be fastened thereafter in a simple manner by means of the screws 36. Subsequently, only the coupling with the actuating element has to be made and the cover 48 has to be fastened by pushing the nose 50 behind the mounting plate 28 of the gearing. Thus, a control valve is obtained that can be manufactured with little assembly and manufacturing effort and is thus economic to produce.

It should be understood that various modifications are conceivable within the scope of protection of the main claim. For example, a comparable configuration for other applications such as wastegate valves or exhaust gas flaps is just as well conceivable as is the use of flap valves for controlling the exhaust gas flow. In this case, the heat shield, which is formed integrally with the housing, must merely be placed between the heat radiating part of the internal combustion engine and the actuator in such a manner that it possibly covers all of the actuator. An additional improvement could be obtained by a cooling duct provided in the housing, via which the housing is cooled, so that the heat absorbed by the heat shield can be discharged via the coolant in addition to the discharge via ambient air. Such an embodiment would offer the additional advantage of an enhanced heat transfer to the flange, whereby the heat discharge would be improved once more when compared to individually manufactured heat shields.

1-11. (canceled)

12. A control valve for installation on an internal combustion engine, the control valve comprising:
a housing comprising an inlet and an outlet;
a passage arranged between the inlet and the outlet and being configured to connect the inlet with the outlet;
a control body configured to control the passage;
an actuating element to which the control body is fixed;
an actuator configured to move the actuating element, the actuator being fixed to the housing; and
a heat shield arranged between the actuator and the internal combustion engine, the heat shield being integrally formed with the housing of the control valve.

13. The control valve as recited in claim 12, wherein the housing is provided as a light metal casting.

14. The control valve as recited in claim 12, further comprising a gearing arranged between the actuator and the heat shield, the gearing being configured to couple the actuator with the actuating element.

15. The control valve as recited in claim 12, further comprising an outer housing comprising a second housing part and a plug configured to extend outward from the second housing part, the plug being configured for a power supply to the actuator, wherein a projected area of the actuator, without the plug, in a direction of the heat shield is smaller than an area of the heat shield.

16. The control valve as recited in claim 12, wherein the heat shield is configured to extend around the gearing in a substantially semi-circular shape.

17. The control valve as recited in claim 14, wherein the control valve is configured as a plug-in-valve comprising a control channel, and the housing further comprises a flange, the housing being configured to be plugged into the control channel and to be fastened to the control channels via the flange.

18. The control valve as recited in claim 17, wherein the heat shield extends vertically from the flange.

19. The control valve as recited in claim 17, wherein the flange comprises an opening, and further comprising a valve rod configured extend through the opening into the gearing so as to act as the actuating element.

20. The control valve as recited in claim 17, further comprising a mounting plate configured to extend from the flange in a direction parallel to the heat shield, the mounting plate being configured to accommodate a part of the gearing and to have the actuator be fastened thereto on a side averted from the heat shield.

21. The control valve as recited in claim 20, further comprising a cover arranged on a side of the mounting plate facing the heat shield, the cover being configured to cover the gearing.

22. The control valve as recited in claim 12, wherein the control valve is an exhaust gas recirculation valve and the actuator comprises an electric motor.
